(19) United States
(12) Patent Application Publication
(10) Pub. No.: US 2026/0161179 A1
(43) Pub. Date: Jun. 11, 2026

(54) METHOD AND DEVICE WITH PATH TRACKING

(71) Applicant: Samsung Electronics Co., Ltd., Suwon-si (KR)

(72) Inventors: Hyunsoo CHA, Suwon-si (KR); Gunhee KOO, Suwon-si (KR); ByeongJu LEE, Suwon-si (KR); Young Rae CHO, Suwon-si (KR)

(73) Assignee: Samsung Electronics Co., Ltd., Suwon-si (KR)

(21) Appl. No.: 19/216,451

(22) Filed: May 22, 2025

(30) Foreign Application Priority Data
Dec. 5, 2024 (KR) 10-2024-0179957

(51) Int. Cl. G05D 1/646; G05D 1/644; G05D 109/10; G05D 111/50

(52) U.S. Cl. CPC G05D 1/646; G05D 1/644; G05D 2109/10; G05D 2111/52

(57) ABSTRACT

A method of tracking a path is performed by an electronic device including wheels, and the method includes: selecting a target point on a target path; determining a target angular velocity or a target velocity based on the target point and a current state of the electronic device; and determining speeds of the respective wheels of the electronic device based on the target angular velocity and the target velocity, wherein the target velocity is determined based on a first linear velocity with respect to a current position of the electronic device, a second linear velocity with respect to a curvature preview position, or a third linear velocity.

### CROSS-REFERENCE TO RELATED APPLICATIONS

This application claims the benefit under 35 USC § 119(a) of Korean Patent Application No. 10-2024-0179957, filed on Dec. 5, 2024, in the Korean Intellectual Property Office, the entire disclosure of which is incorporated herein by reference for all purposes.

### BACKGROUND

### 1. Field

The following description relates to a method and device with path tracking.

### 2. Description of Related Art

A mobile robot may move to a target point or perform a task in various environments and may be used in various industries, such as manufacturing, logistics, and autonomous driving. A mobile robot may move along a given path by path generation and path tracking techniques.

The path generation technique may convert a target path into a series of points to be travelled to, with the path providing direction and position information that the mobile robot needs to follow. The path tracking technique may cause the mobile robot to generate appropriate velocity and steering instructions based on a current state and a given path.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of tracking a path is performed by an electronic device including wheels, and the method includes: selecting a target point on a target path; determining a target angular velocity or a target velocity based on the target point and a current state of the electronic device; and determining speeds of the respective wheels of the electronic device based on the target angular velocity and the target velocity, wherein the target velocity is determined based on a first linear velocity with respect to a current position of the electronic device, a second linear velocity with respect to a curvature preview position, or a third linear velocity.

The target point may be a point selected to be a point of the target path that is closest to the current position of the electronic device.

The target angular velocity may be determined based on a lateral distance error between the target point and the current position of the electronic device and based on a heading angle error of the electronic device.

The first linear velocity may be determined based on a friction coefficient between the wheels of the electronic device and a physical surface and based on a first curvature value with respect to the current position of the electronic device.

The second linear velocity may be determined based on a friction coefficient between the wheels of the electronic device and a physical surface and based on a second curvature value with respect to a curvature preview position of the electronic device.

The curvature preview position may be determined based on a position selected to be a shortest path to the target path based on a position by a curvature preview distance to be traveled by the electronic device.

The curvature preview distance may be determined based on a preview time and a current velocity of the electronic device.

The determining of the target velocity may include applying a maximum friction circle model based on a friction coefficient between the wheels of the electronic device and a physical surface.

The speeds of the respective wheels may be determined using a skid-steering kinetic model.

The method may further include: updating target waypoints based on sensor data of the electronic device; updating the target path based on the sensor data and the target waypoints; and updating a first curvature value with respect to the current position of the electronic device and a second curvature value with respect to the curvature preview position of the electronic device based on the updated target path.

In another general aspect, a path tracker includes: one or more processors; and memory storing instructions configured to cause the one or more processors to: select a target point on a target path; determine a target angular velocity or a target velocity, based on the target point and a current state of an electronic device including wheels; and determine speed of the respective wheels of the electronic device, based on the target angular velocity and the target velocity, wherein the target velocity is determined based on a first linear velocity with respect to a current position of the electronic device, a second linear velocity with respect to a curvature preview position, or a third linear velocity.

The target point may be a point selected to be a point of the target path that is closest to the current position of the electronic device.

The target angular velocity may be determined based on a between the target point and the current position of the electronic device and based on a heading angle error of the electronic device.

The first linear velocity may be determined based on a friction coefficient between the wheel of the electronic device and a physical surface and based on a first curvature value with respect to the current position of the electronic device.

The second linear velocity may be determined based on a friction coefficient between the wheels of the electronic device and a physical surface and based on a second curvature value with respect to a curvature preview position of the electronic device.

The curvature preview position may be determined based on a position selected to be a shortest path to the target path based on a position by a curvature preview distance to be traveled by the electronic device.

The curvature preview distance may be determined based on a preview time and a current velocity of the electronic device.

The target velocity is determined by applying a maximum friction circle model based on a friction coefficient between the wheels of the electronic device and a physical surface.

The speeds of the respective wheels may be determined using a skid-steering kinetic model.

In another general aspect, an electronic device includes: one or more processors; and a memory storing instructions configured to cause the one or more processors to plan and track a path, including: generating target waypoints based on sensor data of the electronic device and performing drive path tracking that tracks a target path based on the target waypoints, wherein the path tracking includes: selecting a target point on the target path of the electronic device, determining a target angular velocity or a target velocity based on the target point and a current state of the electronic device, and determining speeds of respective wheels of the electronic device based on the target angular velocity and the target velocity, wherein the target velocity is determined based on a first linear velocity with respect to a current position of the electronic device, a second linear velocity with respect to a curvature preview position, or a third linear velocity.

Other features and aspects will be apparent from the following detailed description, the drawings, and the claims.

### BRIEF DESCRIPTION OF THE DRAWINGS

FIG. 1 illustrates a path tracking method according to one or more embodiments.

FIG. 2 illustrates a path tracker according to one or more embodiments.

FIG. 3 illustrates target angular velocity determination according to one or more embodiments.

FIG. 4 illustrates target velocity determination according to one or more embodiments.

FIG. 5 illustrates a friction circle model according to one or more embodiments.

FIG. 6 illustrates wheel speed change according to one or more embodiments.

FIG. 7 schematically illustrates an electronic device including a path tracker according to one or more embodiments.

FIG. 8 illustrates an electronic device according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Embodiments and examples described herein relate to a method of path tracking for wheel slip prevention based on tire grip for a skid-steering mobile robot. The skid-steering mobile robot may control a moving direction by adjusting only the speed of each wheel and may circle and move without a separate steering device. In other words, the axes of rotation of the wheels may be fixed with respect to the skid-steering mobile robot, and steering may be effectuated by differences in rotations speeds of the wheels with respect to each other.

A path tracking method may control a mobile robot to move according to a given target path, and, more specifically, may enable the mobile robot to operate based on a target point (also referred to as a waypoint). The path tracking method may identify a current position and a direction of the mobile robot and may generate a required move command using information about the mobile robot's position relative to the target point. For this, the mobile robot may detect surrounding environments using various sensors, such as a global positioning system (GPS), an inertial measurement unit (IMU), and LiDAR, and may estimate a current state of the mobile robot.

A conventional path tracking method may use proportional-integral-derivative (PID) control or pure pursuit schemes. However, since the conventional methods do not sufficiently consider a tire grip limitation of the mobile robot or a curvature change in a path, problems, such as wheel slip or path deviation, may occur. When the curvature rapidly changes, the robot may not stably track the path because the maximum frictional force of the tire is exceeded.

Embodiments and examples described herein may apply to a mobile robot, a path tracking method that considers both the maximum frictional force of a tire and the deceleration ability of the mobile robot. The path tracking performance may be improved by dynamically adjusting target velocity based on information about a curvature on a target path and preemptively reducing the speed by predicting a curvature change in a future path. Accordingly, the mobile robot may stably avoid tire slippage and therefore drive without deviating from the path in various environments.

However, the electronic device to which the embodiments are applied is not limited to the mobile robot and may be used for various electronic devices, such as an autonomous vehicle, industrial transport equipment, etc.

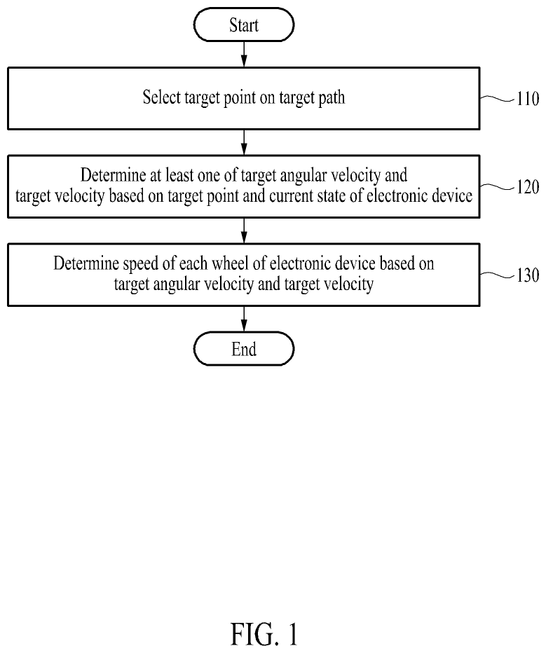

FIG. 1 illustrates a path tracking method according to one or more embodiments.

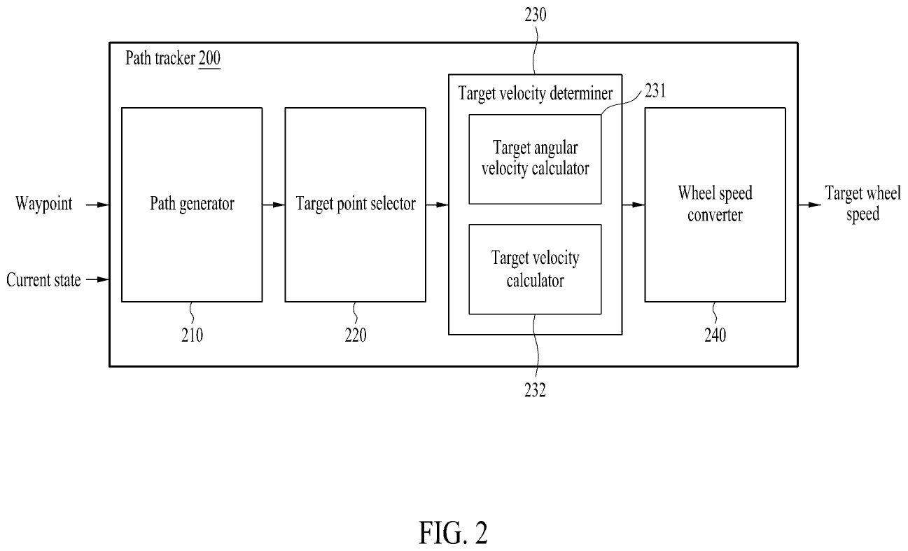

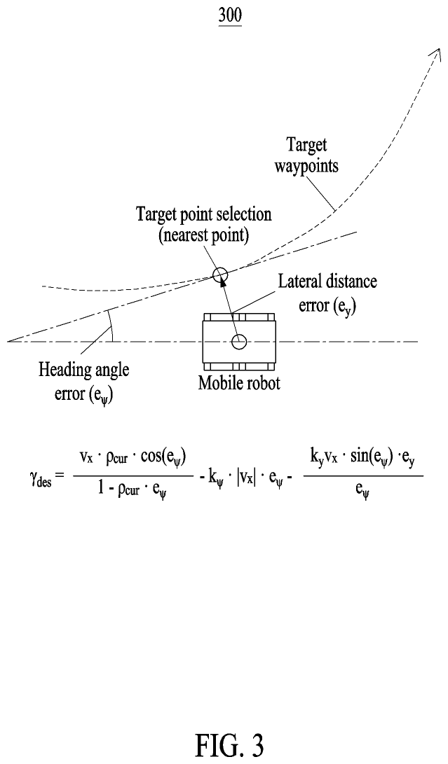

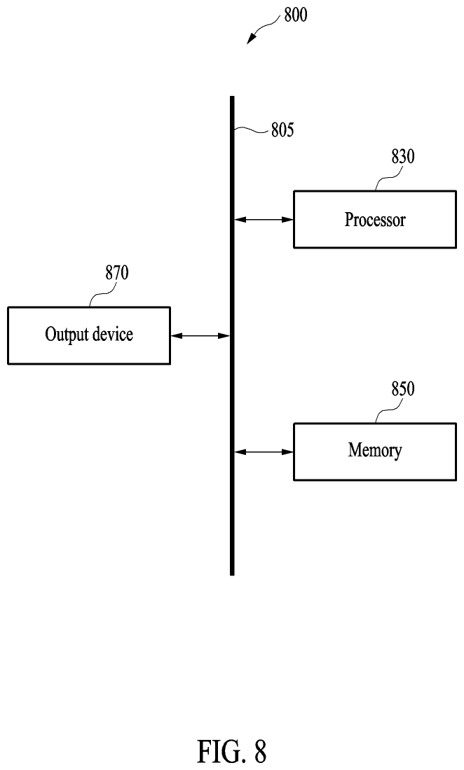

Operations 110 to 130 are described as being performed using a path tracker 200 of FIG. 2 or an electronic device 800 of FIG. 8. However, operations 110 to 130 may be performed by any other appropriate electronic device and in any other appropriate system. Operations 110 to 130 of FIG. 1 are further described with reference to FIGS. 3 to 6.

FIG. 2 illustrates a path tracker according to one or more embodiments.

One or more blocks of FIG. 2 or a combination thereof may be implemented by a special-purpose hardware-based computer configured to perform a specific function or a combination of computer instructions and special-purpose hardware. In some implementations, the blocks in FIG. 2 represent units of instructions (e.g., application software), however, the functions of the units in FIG. 2 may be provided with other modular structures.

Referring to FIGS. 1 and 2, a path tracker 200 may include a target point selector 220, a target velocity determiner 230, and a wheel speed converter 240. The path tracker 200 may further include a path generator 210 that generates a target path from waypoints.

In operation 110, the path tracker 200 may select a target point on a target path through the target point selector 220.

The target point may be a point selected to be a point on the target path that is closest to a current position of an electronic device 800.

The target point selector 220 may identify the most suitable target point based on the current state of the electronic device 800 (e.g., position, heading, linear velocity, etc.) using information about the target path having a continuous curve shape generated by the path generator 210.

The current state may be provided through sensor data, such as GPS information, velocity, and a direction angle of the electronic device 800. The target point selector 220 may select the target point for the electronic device 800 to be such that the electronic device 800 follows the path without deviating (e.g., sliding or skidding) from the path.

For example, when the path generated by the path generator 210 is a curve, the target point selector 220 may calculate a position on the curved path that is closest to the current position of the electronic device 800 and may select the calculated position. The target point selector 220 may be performed to minimize a sum of a longitudinal/linear distance and a lateral distance. The selected target point may be transmitted to the target velocity determiner 230 and the wheel speed converter 240 of the path tracker 200 and may be used to control a moving direction and speed of the electronic device 800.

In operation 120, the path tracker 200 may determine target angular velocity and/or target velocity based on the current state of the electronic device 800 and the target point through the target velocity determiner 230.

The target velocity determiner 230 according to an embodiment may determine the target velocity based on a first longitudinal speed with respect to the current position of the electronic device 800, a second longitudinal speed with respect to a curvature preview position, and/or a third longitudinal speed (e.g., a default longitudinal speed).

The target velocity determiner 230 according to an embodiment may include a target angular velocity calculator 231 and/or a target velocity calculator 232.

FIG. 3 illustrates target angular velocity determination according to one or more embodiments.

Referring to FIGS. 1 to 3, the target angular velocity may be determined based on (i) a lateral distance error between a target point and a current position of the electronic device 800 and based on (ii) a heading angle error; the target angular velocity may be determined by a method 300 of determining target angular velocity.

Referring to FIG. 3, the target angular velocity determiner 230 may calculate the target angular velocity by the target angular velocity calculator 231 for the electronic device 800 to reach the target point. Equation 1 shown below may be a mathematical expression to calculate target angular velocity (γ_{des}).

$${γ}_{des} = \frac{{v}_{x} \cdot {ρ}_{cur} \cdot cos ( {e}_{ψ} )}{1 - {ρ}_{cur} \cdot {e}_{ψ}} - {k}_{ψ} \cdot \vert {v}_{x} \vert \cdot {e}_{ψ} - \frac{{k}_{y} {v}_{x} \cdot sin ( {e}_{ψ} ) \cdot {e}_{y}}{{e}_{ψ}} \qquad Equation 1$$

In Equation 1, γ_{des} denotes target angular velocity, vₓ denotes the current longitudinal/linear velocity of the electronic device 800, ρ_{cur} denotes a path curvature value at the current nearest position/point, e_{ψ} denotes a heading angle error, e_{y} denotes a lateral distance error (point on the path nearest the mobile robot, e.g., tangential to the path), k_{ψ} denotes a constant for the heading angle error, and k_{y} denotes a constant for the lateral distance error. To summarize, the lateral distance error is how far the mobile robot is from the intended travel path, and the heading angle error is the difference between the heading of the mobile robot and the true heading (tangent of the path at the target/nearest point on the path).

The target angular velocity (γ_{des}) may be calculated by considering (based on) both the heading angle error and the lateral distance error, among other factors. The heading angle error is the angle between the tangential direction of the target point and the travel direction of the electronic device 800 (e.g., mobile robot) and the lateral distance error may be defined by a distance between the current position of the electronic device 800 and the target point.

The target angular velocity calculator 231 may calculate the target angular velocity by Equation 1 to allow the electronic device 800 to stably converge to the target point (which moves on the path with the electronic device 800, i.e., different target waypoints are computed as the electronic device 800 travels). A calculation result of the target angular velocity may be transmitted to the wheel speed converter 240 and may be used to control the speed of each wheel of the electronic device 800.

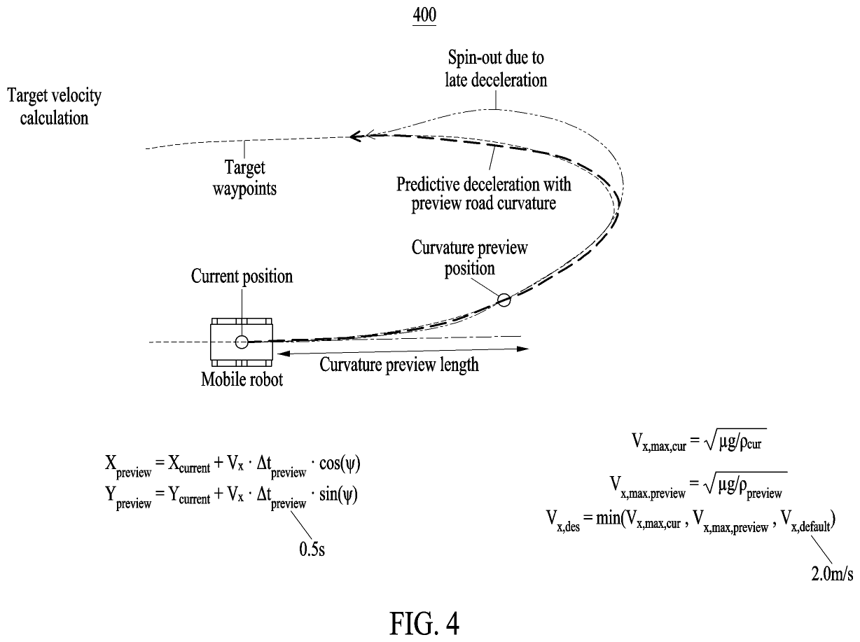

Some variables related to target velocity calculation (FIG. 4) are mentioned before proceeding with description of FIG. 4.

The first/current longitudinal/linear velocity may be determined, for example, based on a friction coefficient between a wheel of the electronic device 800 and a road/travel surface and a first curvature value with respect to the current position of the electronic device 800.

The second/preview longitudinal/linear velocity may be determined based on the friction coefficient between the wheel of the electronic device 800 and the road/travel surface and a second curvature value with respect to a curvature preview position (projected position) of the electronic device 800.

The longitudinal velocity is a speed of the electronic device 800 (e.g., a mobile robot, an autonomous vehicle, etc.) in a travel direction (front and rear directions). Longitudinal velocity may be a velocity component moving along a moving path of the electronic device 800 and may be one of the important factors for assessing the driving performance and stability.

A curvature preview length/distance may be determined based on the current longitudinal velocity of the electronic device 800 and a preview time (i.e., a duration of time for which motion is projected into the future).

The curvature preview position may be determined based on a position selected to be (i) the shortest path on the target path (i.e., “Target waypoints” path in FIGS. 3 and 4) from (ii) a position at the curvature preview length projected to be traveled by the electronic device 800. In other words, the curvature preview position is the position where the mobile robot would end up if it traveled on the target path for a traveled-distance equal the curvature preview length.

Determination of the target velocity determination is now described with reference to FIG. 4.

FIG. 4 illustrates target velocity determination according to one or more embodiments. Here, “velocity” without mention of “angular”, refers to longitudinal/linear velocity.

Referring to FIGS. 1 to 4, the target velocity determiner 230 may calculate the appropriate target velocity by the target velocity calculator 232 based on a current position of the electronic device 800 and forward path information, and may do so in a way that prevents the electronic device 800 from deviating from (spinning out) the path. The target velocity calculator 232 may calculate the target velocity of the electronic device 800 by a method 400 of calculating target velocity. The calculation of the target velocity may be performed using a current curvature value of the path (target waypoints) and curvature preview information to allow electronic device 800 to stably drive a target path generated from target waypoints.

The following two pieces of information may be required to determine the target velocity. The two pieces of information may be (i) a first curvature value (ρ_{cur}) at the current position and (ii) a second curvature value (ρ_{preview}) at a forward position at a curvature preview length.

The curvature preview length may be calculated (e.g., x_{preview}=x_{current}+vₓ. Δt_{preview}·cos(ψ)) based on the current velocity (vₓ) of the electronic device 800 and a preview time Δt_{preview}. For example, when the preview time is set to 0.5 seconds, the curvature preview length may be a distance that the electronic device 800 would travel if it moved at the current velocity in the longitudinal direction (straight forward) for 0.5 seconds.

The curvature preview position may be defined as a position that is closest to the target path from a point forwardly traveled along the curvature preview length of the target path. The curvature preview position may be the information used to calculate the target velocity.

A current first curvature value (ρ_{cur}) may indicate a curvature of that path at the closest point from the current position of the electronic device 800, and, a preview second curvature value (ρ_{preview}) may be a path curvature at the curvature preview position. Each curvature value may be used to set a speed limit.

A maximum longitudinal velocity (v_{x,max,cur}) (e.g., the first longitudinal velocity) with respect to the current position may be calculated by Equation 2 below.

$${v}_{x , max , cur} = \sqrt{μ g / {ρ}_{cur}} \qquad Equation 2$$

In this case, μ denotes a friction coefficient with the road surface, and g denotes gravitational acceleration.

A maximum longitudinal velocity (v_{x,max,preview}) (e.g., the second longitudinal velocity) with respect to the curvature preview position may be calculated by Equation 3 below.

$${v}_{x , max , preview} = \sqrt{μ g / {ρ}_{preview}} \qquad Equation 3$$

In this case, the target velocity determiner 230 may determine final target velocity (v_{x,des}) to be the smallest value from the following three values. The target velocity may be determined to be one of (i) the maximum longitudinal velocity (v_{x,max,cur}) with respect to the current position, (ii) the maximum longitudinal velocity (v_{x,max,preview}) with respect to the curvature preview position, and (iii) an initial longitudinal velocity (v_{x,default}).

For example, when (v_{x,default}) is set to 2.0 m/s, the smallest value of the three velocity values of the electronic device 800 may be selected to be the final target velocity.

The target velocity determiner 230 may determine appropriate velocity based on the path curvature and forward prediction information to prevent the electronic device 800 from deviating from the path.

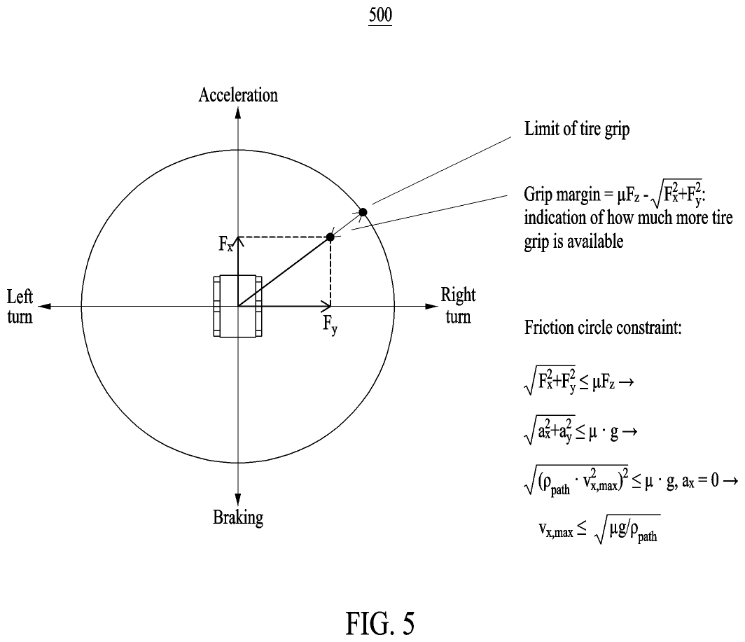

The target velocity determiner 230 according to an embodiment may determine the target velocity by applying a maximum friction circle model based on the friction coefficient between the wheel of the electronic device 800 and the road surface. The friction circle model is described next with reference to FIG. 5.

FIG. 5 illustrates a friction circle model according to one or more embodiments.

Referring to FIGS. 1 to 5, a friction circle is a circular area indicating a maximum frictional force that a tire of the electronic device 800 may generate on a road surface and may indicate the relationship between longitudinal and lateral acceleration. A friction circle model 500 may ensure the driving safety of the electronic device 800 and may provide important information for path curvature and speed control.

Fₓ is a force generated by longitudinal acceleration, F_{y} is a force generated by lateral acceleration, μ is a friction coefficient between the wheel and the road surface, and F_{z} is a vertical load applied to the tire of the electronic device 800.

A constraint of the friction circle may be defined as Equation 4 below.

$$\sqrt{{F}_{x}^{2} + {F}_{y}^{2}} \leq μ {F}_{z} \qquad Equation 4$$

The constraint may be changed to Equation 5.

$$\sqrt{{a}_{x}^{2} = {a}_{y}^{2}} \leq μ \cdot g \qquad Equation 5$$

In this case, aₓ denotes the longitudinal acceleration, d_{y} denotes the lateral acceleration, and g denotes the gravitational acceleration.

To determine the target velocity, the equation defining the friction circle model 500 may be used to calculate the maximum velocity related to the path curvature value. The maximum velocity (v_{x,max}) may be calculated by Equations 6 and 7 below based on the curvature value (ρₚₐₜₕ) of the current path. In this case,

$${a}_{y} = {ρ}_{p a t h} {v}_{x , max}^{2}$$

may be satisfied and the longitudinal acceleration may be 0, i.e., aₓ=0.

$$\sqrt{{( {ρ}_{path} \cdot {v}_{x , max}^{2} )}^{2}} \leq μ \cdot g , {a}_{y} = 0 \qquad Equation 6$$

$${v}_{x , max} \leq \sqrt{μ g / {ρ}_{path}} \qquad Equation 7$$

A grip margin denotes a margin between the maximum frictional force and a tire contact condition of the current wheel and may be defined by Equation 8.

$$μ {F}_{z} - \sqrt{{F}_{x}^{2} + {F}_{y}^{2}} \qquad Equation 8$$

The friction circle model 500 may enable the electronic device 800 to stably drive even on a path with a rapidly changing curvature. When the electronic device 800 moves along a path, path deviation may be prevented by maintaining the balance between the longitudinal acceleration and the lateral acceleration using the friction circle model 500. This may allow dynamic adjustment of the target velocity, thereby supporting the electronic device 800 in stably tracking the path.

In addition, when the friction circle model 500 is used, the electronic device 800 may be designed to preemptively perform deceleration by predicting a curvature of a forward path and a curvature preview position. This may enable stable control of the electronic device 800 even with a rapid curvature change or an environmental constraint.

In operation 130, the path tracker 200 may the velocity of each wheel of the electronic device 800 based on the target angular velocity and the target velocity by using the wheel speed converter 240.

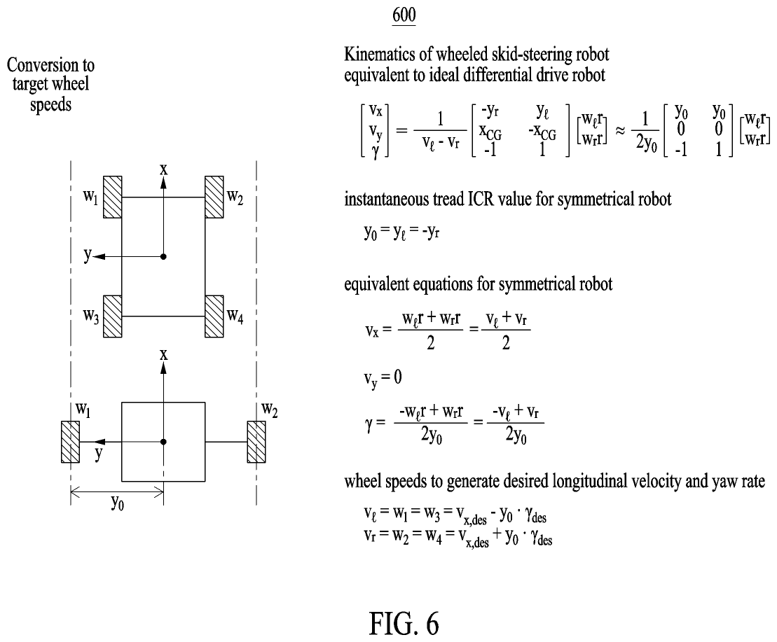

The wheel speed converter 240 may determine wheel speed using a skid-steering kinetic model. The wheel speed conversion is described with reference to FIG. 6.

FIG. 6 illustrates wheel speed change according to one or more embodiments.

Referring to FIGS. 1 to 6, the wheel speed converter 240 may calculate the four-wheel speed of the electronic device 800 based on the target longitudinal velocity (vₓ, des) and the target angular velocity (γ_{des}). The wheel speed converter 240 may use the characteristic that the kinematics of a skid-steering robot is geometrically equal to a model of an ideal differential drive robot (i.e., instantaneous center of rotation (ICR) robot) through a wheel speed conversion method 600. The kinematics of the skid-steering robot may be converted into the model of the ICR robot based on Equations 9 and 10 below.

$$[ \begin{matrix}{v}_{x} \\ {v}_{y} \\ γ\end{matrix} ] = \frac{1}{{v}_{l} - {v}_{r}} [ \begin{matrix}- {y}_{r} & {y}_{l} \\ {x}_{CG} & - {x}_{CG} \\ - 1 & 1\end{matrix} ] [ \begin{matrix}{w}_{l} r \\ {w}_{r} r\end{matrix} ] \approx \frac{1}{2 {y}_{0}} [ \begin{matrix}{y}_{0} & {y}_{0} \\ 0 & 0 \\ - 1 & 1\end{matrix} ] [ \begin{matrix}{w}_{l} r \\ {w}_{r} r\end{matrix} ] \qquad Equation 9$$

In this case, vₓ is the longitudinal velocity, v_{y} is the lateral velocity (considered as “0” for the skid-steering robot), γ is a yaw rate, w_{L} and w_{R} are speeds of the left and right wheels, respectively, r is a wheel radius, and y₀ (y₀=yₗ=−yᵣ) is a virtual distance between the centers of the left and right wheels.

$${v}_{x} = \frac{{w}_{L} r + {w}_{R} r}{2} , {v}_{y} = 0 , γ = \frac{( {w}_{R} r - {w}_{L} r )}{2 {y}_{0}} \qquad Equation 10$$

The model of the ICR robot may be based on the assumption that an instantaneous center of four wheels is at the center of the electronic device 800 and a moving direction and rotation velocity of the electronic device 800 may be controlled by the speeds of left and right wheels.

The speed of each wheel may be calculated by Equation 11 based on the target velocity and target angular velocity.

$${v}_{L} = {w}_{1} = {w}_{3} = {v}_{x , d e s} - {y}_{0} \cdot {γ}_{d e s} \qquad Equation 11$$

$${v}_{R} = {w}_{2} = {w}_{4} = {v}_{x , d e s} + {y}_{0} \cdot {γ}_{d e s}$$

In this case, v_{L} is the left wheel speed (w₁ and w₃), and v_{R} is the right wheel speed (w₂ and w₄). Equation 11 may enable the electronic device 800 to stably drive by calculating the speeds of four wheels in a balanced manner based on the target velocity (v_{x,des} and the target angular velocity (γ_{des}).

However, a virtual instantaneous central distance (y₀) may differ from an actual physical distance between wheels. For example, when y₀ is set to 2.1 m, the actual physical distance between the left wheel and the right wheel of the electronic device 800 may be approximately 0.55 m.

Through the wheel speed converter 240, the path tracker 200 may calculate the speed of each wheel based on the target velocity and the target angular velocity, and through this, the electronic device 800 may stably and efficiently track the path. The path tracker 200 may enable the electronic device 800 to maintain driving stability even on a path with a rapidly changing curvature.

The electronic device 800 according to an embodiment may update target waypoints based on the sensor data of the electronic device 800. The electronic device 800 may update a target path based on the sensor data and the target waypoints. The electronic device 800 may update a first curvature value with respect to the current position of the electronic device 800 and a second curvature value with respect to a curvature preview position of the electronic device 800, based on the updated target path.

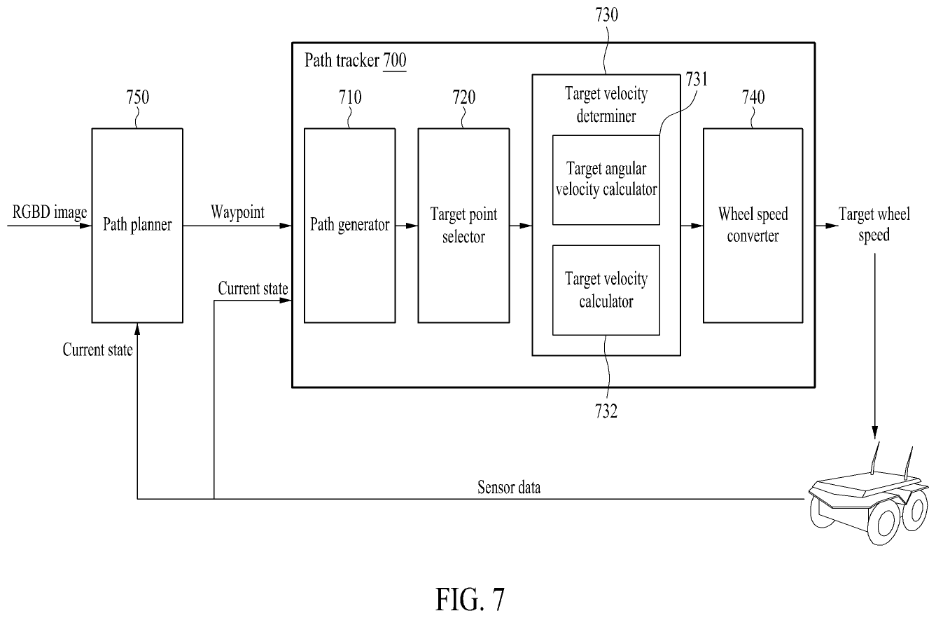

FIG. 7 illustrates the electronic device 800 including a path tracker according to one or more embodiments.

One or more blocks of FIG. 7 or a combination thereof may be implemented by a special-purpose hardware-based computer configured to perform a specific function or a combination of computer instructions in a general purpose computer and/or in a special-purpose hardware.

Referring to FIGS. 1 to 7, the electronic device 800 is illustrated when a path tracker 700 is implemented together with a path planner 750. The path planner 750 may generate a target waypoint based on relative distance information and an image of a front object by receiving red, green, blue, depth (RGBD) image data. In this process, a path generator 710 may generate a target path on which the electronic device needs to move by additionally utilizing the current position of the electronic device 800 and velocity information (odometry information) on the electronic device 800. The path planner 750 may be implemented in various manners and in the described embodiments, an input/output relationship of the path planner 750 is described as an example.

The path tracker 700 may receive the target waypoint generated by the path planner 750 and may receive current state information from a GPU, an IMU, and a wheel speed sensor mounted on the electronic device 800, as non-limiting examples. The path tracker 700 may generate a control command required to track the target path (e.g., move towards the received target waypoint) based on the input data. More specifically, the path tracker 700 may select a target point through the target point selector 720. The path tracker 700 may calculate the target angular velocity and the target velocity by analyzing a relationship between the target point and the current state of the electronic device 800 through the target velocity determiner 730.

The target velocity may be calculated by considering a first longitudinal velocity with respect to the current position of the electronic device 800, a second longitudinal velocity with respect to a curvature preview position, and/or an initial longitudinal velocity (a third longitudinal velocity), through a target velocity calculator 731.

The target angular velocity may be calculated based on a lateral distance error between the target point and the current position of the electronic device 800 and a heading angle error, through the target angular velocity calculator 732.

The path tracker 700 may calculate wheel speed through a wheel speed converter 740 based on the calculated target angular velocity and the calculated target velocity and may control the wheel speed of each of the four wheels of the electronic device 800 using the calculated wheel speed. The path tracker 700 may enable the electronic device 800 to accurately track the target path and maintain stable driving performance even in a section in which curvature rapidly changes.

The path tracker 700 may drive an algorithm that may secure both the stability and accuracy of a driving path and may effectively control the driving function of the electronic device 800 in various environments.

FIG. 8 illustrates an electronic device according to one or more embodiments.

The description provided with reference to FIGS. 1 to 7 is generally applicable to the example of FIG. 8.

Referring to FIG. 8, the electronic device 800 according to an embodiment may include a processor 830, a memory 850, and an output device 870 (e.g., a display). The processor 830, the memory 850, and the output device 870 may be connected to each other via a communication bus 805. The electronic device 800 may include the processor 830 configured to perform at least one of the methods described above or an algorithm corresponding to the at least one method for the operations of the electronic device 800.

The output device 870 may display a target path and a control result provided by the processor 830. The output device 870 may be the same device as the display included in the electronic device 800. In addition, to display the target path and the control result, the output device 870 may be built into the electronic device 800 or may be an external display device.

The memory 850 may store data related to the path tracking method performed by the processor 830 and relevant data. In addition, the memory 850 may store a variety of information generated in a processing process of the processor 830 described above. In addition, the memory 850 may store a variety of data and programs. The memory 850 may include a volatile memory or a non-volatile memory. The memory 850 may include a large-capacity storage medium such as a hard disk to store a variety of data.

In addition, the processor 830 may perform at least one method described above with reference to FIGS. 1 to 7 or an algorithm corresponding to the at least one method. In the above descriptions, the processor 830 may be a data processing device implemented by hardware including a circuit having a physical structure to perform desired operations. For example, the desired operations may include code or instructions included in a program. The processor 830 may be configured as, for example, any of, or a combination of, a central processing unit (CPU), a graphics processing unit (GPU), a neural network processing unit (NPU), or the like. For example, the hardware-implemented electronic device 800 may include a microprocessor, a CPU, a processor core, a multi-core processor, a multiprocessor, an application-specific integrated circuit (ASIC), and a field-programmable gate array (FPGA).

The processor 830 may execute a program and may control the electronic device 800. Program codes to be executed by the processor 830 may be stored in the memory 850. Although mathematical notation and equations are used herein, such mathematical notation and equations are not the direct subject of this disclosure. Rather, the mathematical equations are a concise guide that a software engineer may use to craft source code that can be compiled into instructions that, when executed by the processor 830, cause the processor 830 to perform in a manner analogous to the mathematical equations. That is to say, the mathematical notation and equations are a shorthand replacement for equivalent (and verbose) equivalent text.

The computing apparatuses, the vehicles, the electronic devices, the processors, the memories, the image sensors, the vehicle/operation function hardware, the displays, the information output system and hardware, the storage devices, and other apparatuses, devices, units, modules, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method of tracking a path performed by an electronic device comprising wheels, the method comprising:
selecting a target point on a target path;
determining a target angular velocity or a target velocity based on the target point and a current state of the electronic device; and
determining speeds of the respective wheels of the electronic device based on the target angular velocity and the target velocity,
wherein the target velocity is determined based on a first linear velocity with respect to a current position of the electronic device, a second linear velocity with respect to a curvature preview position, or a third linear velocity.

2. The method of claim 1, wherein the target point is a point selected to be a point of the target path that is closest to the current position of the electronic device.

3. The method of claim 1, wherein the target angular velocity is determined based on a lateral distance error between the target point and the current position of the electronic device and based on a heading angle error of the electronic device.

4. The method of claim 1, wherein the first linear velocity is determined based on a friction coefficient between the wheels of the electronic device and a physical surface and based on a first curvature value with respect to the current position of the electronic device.

5. The method of claim 1, wherein the second linear velocity is determined based on a friction coefficient between the wheels of the electronic device and a physical surface and based on a second curvature value with respect to a curvature preview position of the electronic device.

6. The method of claim 1, wherein the curvature preview position is determined based on a position selected to be a shortest path to the target path based on a position by a curvature preview distance to be traveled by the electronic device.

7. The method of claim 6, wherein the curvature preview distance is determined based on a preview time and a current velocity of the electronic device.

8. The method of claim 1, wherein the determining of the target velocity comprises applying a maximum friction circle model based on a friction coefficient between the wheels of the electronic device and a physical surface.

9. The method of claim 1, wherein the speeds of the respective wheels are determined using a skid-steering kinetic model.

10. The method of claim 1, further comprising:
updating target waypoints based on sensor data of the electronic device;
updating the target path based on the sensor data and the target waypoints; and
updating a first curvature value with respect to the current position of the electronic device and a second curvature value with respect to the curvature preview position of the electronic device based on the updated target path.

11. A path tracker comprising:
one or more processors; and
memory storing instructions configured to cause the one or more processors to:
select a target point on a target path;
determine a target angular velocity or a target velocity, based on the target point and a current state of an electronic device comprising wheels; and
determine speed of the respective wheels of the electronic device, based on the target angular velocity and the target velocity,
wherein the target velocity is determined based on a first linear velocity with respect to a current position of the electronic device, a second linear velocity with respect to a curvature preview position, or a third linear velocity.

12. The path tracker of claim 11, wherein the target point is a point selected to be a point of the target path that is closest to the current position of the electronic device.

13. The path tracker of claim 11, wherein the target angular velocity is determined based on a between the target point and the current position of the electronic device and based on a heading angle error of the electronic device.

14. The path tracker of claim 11, wherein the first linear velocity is determined based on a friction coefficient between the wheel of the electronic device and a physical surface and based on a first curvature value with respect to the current position of the electronic device

15. The method of claim 11, wherein the second linear velocity is determined based on a friction coefficient between the wheels of the electronic device and a physical surface and based on a second curvature value with respect to a curvature preview position of the electronic device

16. The path tracker of claim 11, wherein the curvature preview position is determined based on a position selected to be a shortest path to the target path based on a position by a curvature preview distance to be traveled by the electronic device.

17. The path tracker of claim 16, wherein the curvature preview distance is determined based on a preview time and a current velocity of the electronic device.

18. The path tracker of claim 11, wherein the target velocity is determined by applying a maximum friction circle model based on a friction coefficient between the wheels of the electronic device and a physical surface.

19. The path tracker of claim 11, wherein the speeds of the respective wheels are determined using a skid-steering kinetic model.

20. An electronic device comprising:
one or more processors; and
a memory storing instructions configured to cause the one or more processors to plan and track a path, including:
generating target waypoints based on sensor data of the electronic device and performing drive path tracking that tracks a target path based on the target waypoints,
wherein the path tracking includes:
selecting a target point on the target path of the electronic device,
determining a target angular velocity or a target velocity based on the target point and a current state of the electronic device, and
determining speeds of the respective wheels of the electronic device based on the target angular velocity and the target velocity,
wherein the target velocity is determined based on a first linear velocity with respect to a current position of the electronic device, a second linear velocity with respect to a curvature preview position, and a third linear velocity.
